(19) United States
(12) Patent Application Publication
(10) Pub. No.: US 2018/0340371 A1
(43) Pub. Date: Nov. 29, 2018

(54) LADDER SUPPORT SYSTEM AND METHOD

(71) Applicant: John Georges, Happy Valley, OR (US)

(72) Inventor: John Georges, Happy Valley, OR (US)

(21) Appl. No.: 15/990,588

(22) Filed: May 25, 2018

Related U.S. Application Data
(60) Provisional application No. 62/511,915, filed on May 26, 2017.

(51) Int. Cl. E06C 7/42

(52) U.S. Cl. CPC E06C 7/42

(57) ABSTRACT

A support system for providing support to a ladder; the support system includes at least one support arm, at least one support leg, at least one support base, and at least one support bracket. The support leg is removably attached to a lower end of the at least one support arm. The support base is coupled to the at least one support leg and has a plurality of ridge on its lower surface. The support bracket is removably attached to the upper end of the at least one support arm. Altogether, the components of the support system are configured to provide support and relative stability to a ladder.

### CROSS-REFERENCE TO RELATED APPLICATION(S)

The present application is related to and claims priority to U.S. Provisional Patent Application No. 62/511,925 filed May 26, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of ladders of existing art and more specifically relates to ladder stabilizers.

### RELATED ART

Many people use ladders to reach places that are too high for someone to reach without aid. A ladder is a vertical or inclined set of rungs or steps. They are commonly made of metal, wood, or fiberglass, and they have also been known to be made of ‘tough’ plastic. When a full-size ladder is not necessary, a step stool may be used.

Most extension ladders are not designed with safety in mind. If people apply too much weight to one side of a ladder, it can tip. Likewise, when used on uneven terrain, the ladder can tip. Some people may try to shimmy the ladder a certain way or attempt to balance the ladder with makeshift supports, but this isn't very safe. Unfortunately, if ladders crash down, they can not only break or cause damage to surrounding equipment but also cause minor to severe injuries to the user. An effective alternative is needed.

U.S. Pub. No. 2004/0231921 to Paul Ramirez relates to an outrigger stabilizer and ladder combination. The described outrigger stabilizer and ladder combination includes an outrigger stabilizer combined with a ladder that includes a telescoped outer tube and inner elongated member with a one way brake freely allowing telescoping movement of the inner member out of the outer tube to automatically adjust to engage the ground but instantly locking together when any collapsing movement is attempted to brace the ladder in any adjusted position.

### SUMMARY OF THE INVENTION

In view of the foregoing disadvantages inherent in the known ladder stabilizer art, the present disclosure provides a novel ladder support system and method. The general purpose of the present disclosure, which will be described subsequently in greater detail, is to provide extra support and stability to an extension ladder on either side to help prevent horizontal movement, sliding, or even twisting.

A support system for providing support to a ladder is disclosed herein. The support system may include at least one support arm, at least one support leg, at least one support base, and at least one support bracket. The support leg may be removably attached to a lower end of the at least one support arm. The support base may be coupled to the at least one support leg and may have a plurality of ridge on its lower surface. The support bracket may be removably attached to the upper end of the at least one support arm. Altogether, the components of the support system may be configured to provide support and relative stability to a ladder.

According to another embodiment, a method of using a support system for a ladder is also disclosed herein. The method of using a support system for a ladder may include providing at least one support arm from the support system and attaching the at least one support arm from the support system to a ladder for use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a ladder support system and method, constructed and operative according to the teachings of the present disclosure.

FIG. 1 is a perspective view of the ladder support system during an ‘in-use’ condition, according to an embodiment of the disclosure.

FIG. 2 is a side view of the ladder support system of FIG. 1, according to an embodiment of the present disclosure.

FIG. 3 is a top perspective view of the ladder support system of FIG. 1, according to an embodiment of the present disclosure.

FIG. 4A and FIG. 4B are perspective views of the ladder support system of FIG. 1, according to an embodiment of the present disclosure.

FIG. 5 is a flow diagram illustrating a method of using the support system for a ladder, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a ladder stabilizer and more particularly to a ladder support system and method as used to provide extra support and stability to an extension ladder on either side to help prevent horizontal movement, sliding, or even twisting.

Generally, the present invention supports an extension ladder on either side for superior safety and ease of use. As designed, this system may prevent a ladder from tipping over, sliding out, or even twisting. It may reduce damage to ladders from wipe outs and accidents. This system may further eliminate the need for help from another person, increasing speed and efficiency on the job. The present invention enables the use of ladders on uneven terrain or other questionable surfaces.

The support system may be particularly useful in helping to stabilize a ladder for enhanced support on a variety of terrains. This innovative product may comprise an extension ladder support, made preferably from aluminum or other suitable material. The support can include a mounting assembly, adjustable support arm, and a leg apparatus that makes contact with the ground. The mounting assembly can include a number of hooks, screw clamps, and other coupling mechanisms useful for removably and adjustably mounting the support to almost any area of an extension ladder, including the sidewalls, step supports, and base frame. The mounting assembly may further include a hinge mechanism, allowing the device to be adjusted across multiple planes. The adjustable support arm can include a telescoping bracket that allows the device to be extended outwardly. The leg apparatus can include levelers with a spring insert for adapting to uneven terrain and increasing support. On the bottom of the apparatus can be a textured, nonslip material.

The support system may also include additional bracing arms or supports that connect the support arms to the support bracket. Each support bracket may be configured as a single coupling mechanism or as an extended plate to provide support down the long axis of the ladder. The extended plate may be conjoined with the support arm of the support system by means of a secondary brace. The secondary brace may for a triangle in relation to the support arm and the extended plate for additional strength and stability. The secondary brace and extended plate for coupling with the ladder frame may be optional and not necessarily included in all embodiments of this system.

The support system may be used in orthogonal relation to the long axis of the ladder that it is attached to. The supports generally extend at an angle, thereby providing the maximum amount of stability in a variety of situations. In a preferred embodiment, the support system may be positioned on each side of the ladder to angle forwards from the ladder (in the same direction as the ladder) at an angle of approximately 30 degrees. This configuration may allow for even more support still as the support arms would remain relationally about the ladder in a manner that may be beneficial to bearing additional loads or providing lateral stability. The supports may be used in pairs on both sides of the ladder, with each support having the ability to be attached at separate locations on a ladder. This independent attachment configuration may again be useful for providing maximum support on uneven terrain. Upon reading this specification, it should be appreciated that, under appropriate circumstances, considering such issues as user preferences, design preference, structural requirements, marketing preferences, cost, available materials, technological advances, etc., other ladder support arrangements such as, for example, alternative rotator assemblies, etc., may be sufficient.

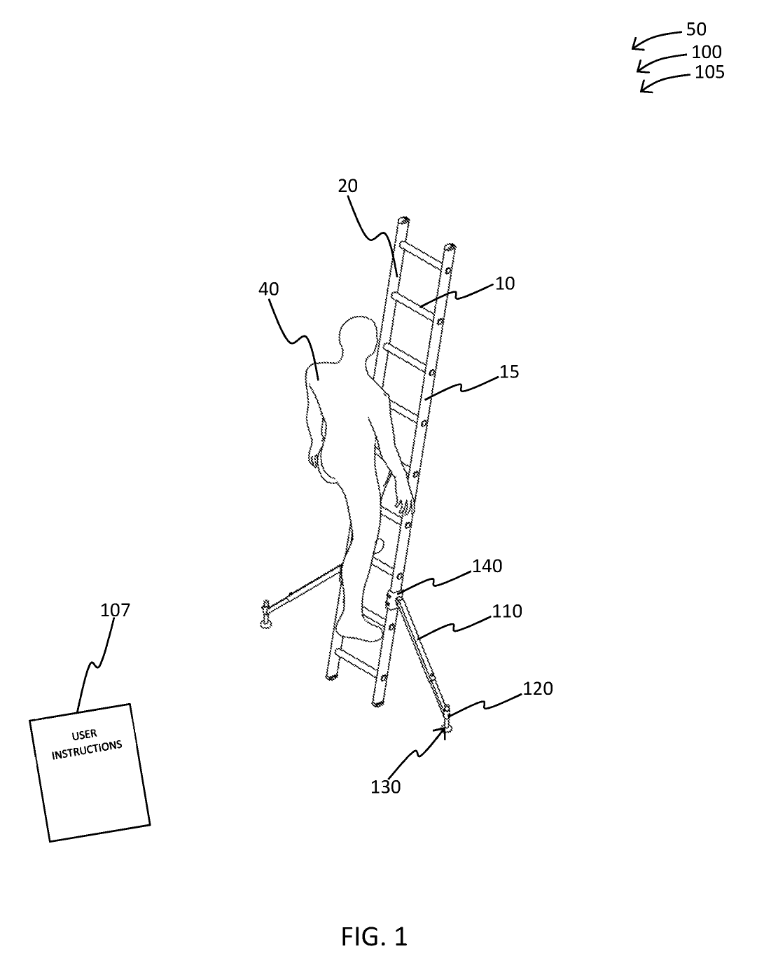

Referring now more specifically to the drawings by numerals of reference, there is shown in FIGS. 1-4, various views of a support system 100.

FIG. 1 shows a support system 100 during an ‘in-use’ condition 50, according to an embodiment of the present disclosure. Here, the support system 100 may be beneficial for use by a user 40 to provide extra support and stability to an extension ladder on either side to help prevent horizontal movement, sliding, or even twisting. As illustrated, the support system 100 for providing support to a ladder 10 may include at least one support arm 110, at least one support leg 120, at least one support base 130, and at least one support bracket 140. The at least one support bracket 140 may be positioned couple with and pivot relative to a first ladder leg 15. A second support arm 110 may be used in conjunction on a second ladder leg 20 for additional support to the ladder 10.

According to one embodiment, the support system 100 may be arranged as a kit 105. In particular, the support system 100 may further include a set of instructions 107. The instructions 107 may detail functional relationships in relation to the structure of the support system 100 such that the support system 100 can be used, maintained, or the like, in a preferred manner.

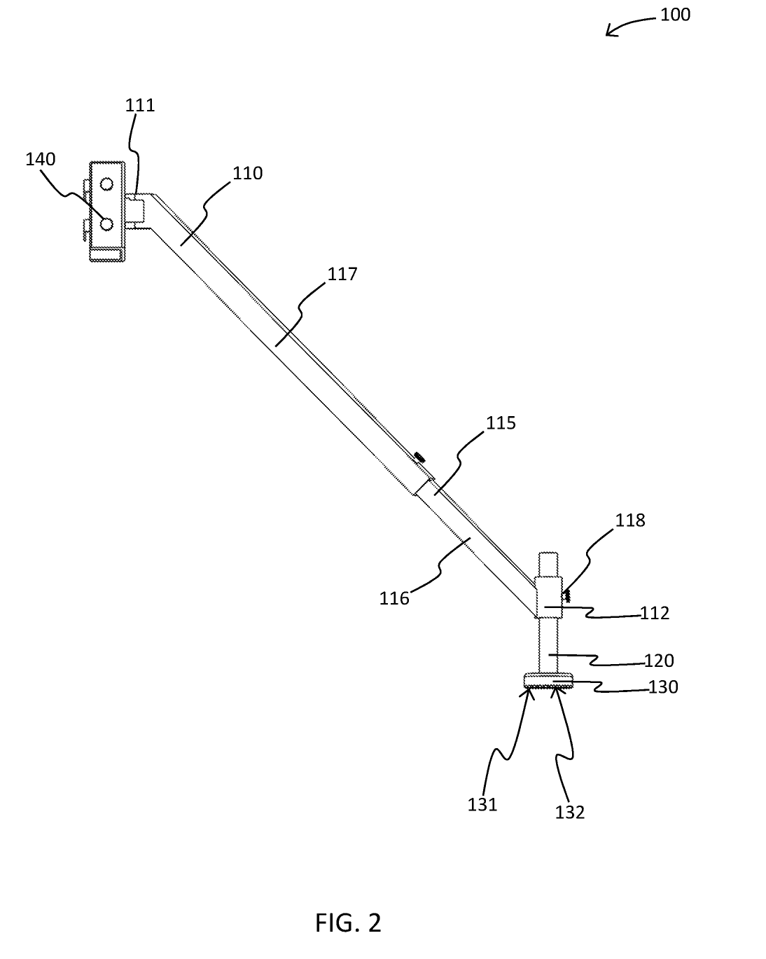

Referring now to FIG. 2 showing the support system 100 of FIG. 1, according to an embodiment of the present disclosure. As above, the support system 100 may include at least one support arm 110 having an upper end 111 and a lower end 112, at least one support leg 120, at least one support base 130, and at least one support bracket 140. The at least one support arm 110 may be configured as a telescoping support arm 115. The at least one support arm 110 may also be comprised of two sections including a first section 116, which may be smaller in size than a second section 117. The support system 100 may also include a fastening means 118 located on the lower end 112 of the at least one support arm 110. The fastening means 118 may be useful for removably attaching the at least one support arm 110 to the at least one support leg 120. The at least one support leg 120 may be coupled to the at least one support base 130. The at least one support base 130 may include a lower surface 132 that has a plurality of ridges 131 for improved traction on a variety of terrain types.

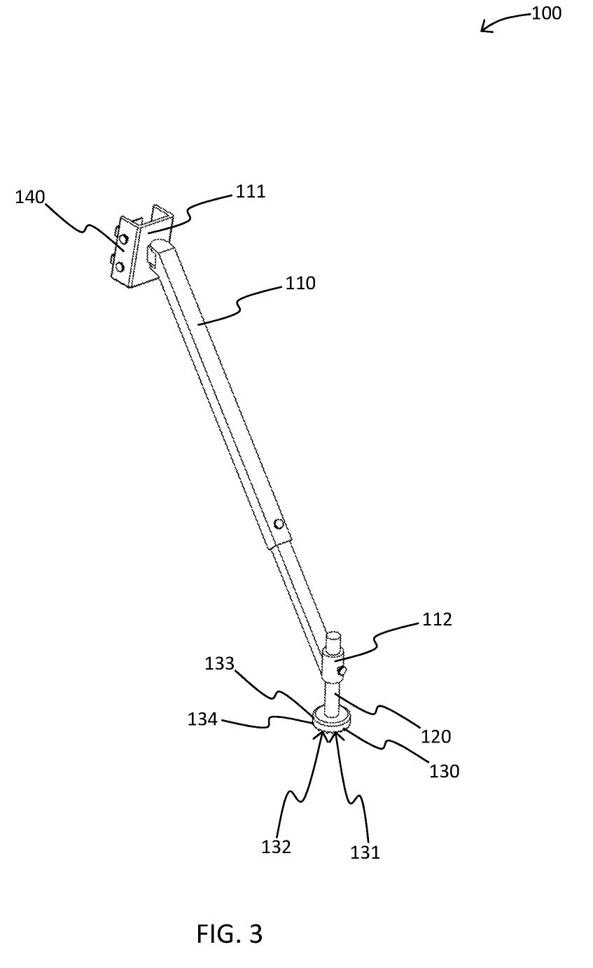

FIG. 3 is a top perspective view of the support system 100 of FIG. 1, according to an embodiment of the present disclosure. Here again, the support system 100 may include at least one support arm 110 having an upper end 111 and a lower end 112, at least one support leg 120, at least one support base 130, and at least one support bracket 140. The at least one support base 130 may include a lower surface 132 that has a plurality of ridges 131 arranged in a radial configuration 133. For additional support, the lower surface 132 of the at least one support base 130 may be made of a non-slip material 134.

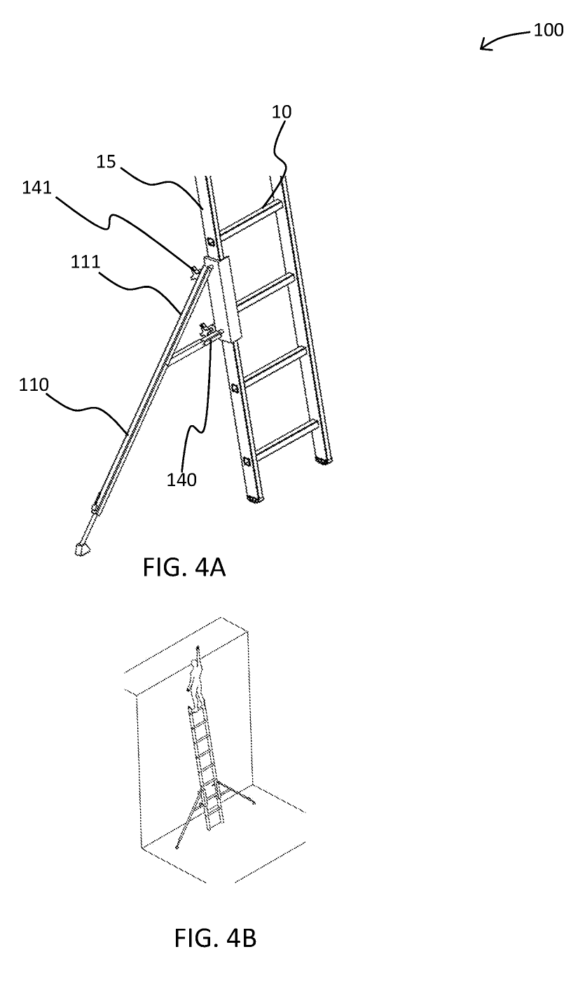

Referring now to FIG. 4A, a perspective view of the support system 100 of FIG. 1, according to an embodiment of the present disclosure. As above, the support system 100 may include at least one support arm 110 having an upper end 111. The at least one support bracket 140 may be removably attached to the upper end 111 of the at least one support arm 110. The at least one support bracket 140 may also include a coupling means 141 that is useful for joining the at least one support arm 110 to a first ladder leg 15 of a ladder 10.

FIG. 4B is a perspective view of the support system 100 of FIG. 1, according to an embodiment of the present disclosure. Here again, the support system 100 is shown in use to provide a secondary illustration of the support system 100 and how it may provide additional lateral stability to help keep a ladder from sliding sideways or in a direction away from where it is leaning.

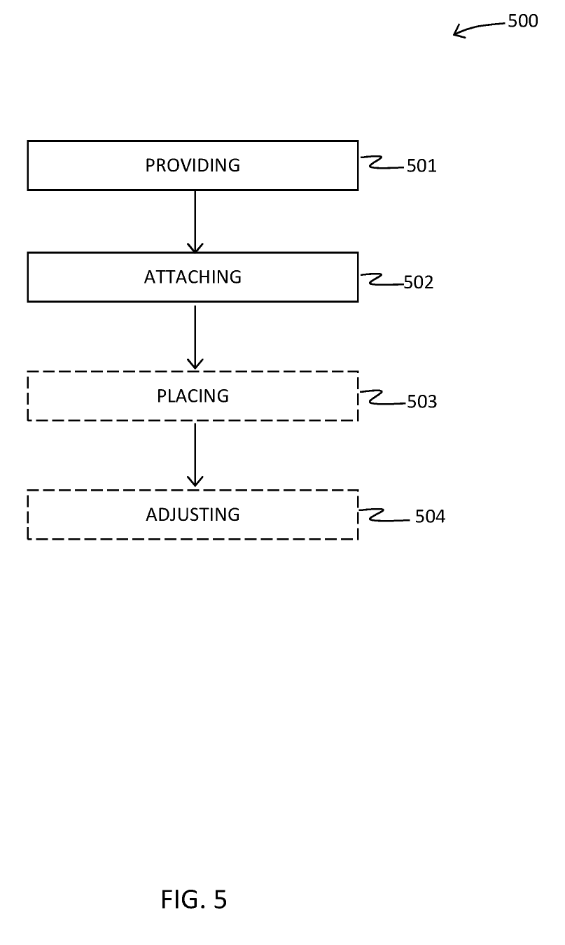

FIG. 5 is a flow diagram illustrating a method 500 of using a support system 100 for a ladder 10, according to an embodiment of the present disclosure. In particular, the method 500 of using a support system 100 may include one or more components or features of the support system 100 as described above. As illustrated, the method 500 of using a support system 100 may include the steps of: step one 501, providing at least one support arm, the at least one support arm having an upper end and a lower end, at least one support leg, the at least one support leg being removably attached to the lower end of at least one support arm, at least one support base, the at least one support base being coupled to the at least one support leg and having a plurality of ridges on a lower surface of the support base, and at least one support bracket, the at least one support bracket being removably attached to the upper end of the at least one support arm; and step two 502, attaching the support system to the ladder.

It should be noted that step 503, placing the ladder in a desired work area, and step 504, adjusting the at least one support arm and at least one support leg to a desired position, are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the support system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A support system for providing support to a ladder, said support system comprising:
at least one support arm, said at least one support arm having an upper end and a lower end;
at least one support leg, said at least one support leg being removably attached to said lower end of at least one support arm;
at least one support base, said at least one support base being coupled to said at least one support leg and having a plurality of ridges on a lower surface of said support base;
at least one support bracket, said at least one support bracket being removably attached to said upper end of said at least one support arm; and
wherein said support system is configured to provide lateral and vertical support and relative stability to said ladder.

2. The support system of claim 1, wherein said at least one support arm is a telescoping support arm.

3. The support system of claim 2, wherein said telescoping support arm is configured to extend said support arm in an outward direction.

4. The support system of claim 1, wherein said lower end of said at least one support arm is cylindrical in shape.

5. The support system of claim 1, wherein said support arm is comprised of two sections.

6. The support system of claim 4, wherein a first of said sections is smaller in size than a second of said sections.

7. The support system of claim 5, wherein said first section is removably attached to said second section via an attachment means.

8. The support of claim 1, further comprising a fastening means located on said lower end of said at least one support arm.

9. The support system of claim 6, wherein said fastening means is configured to removably attach said at least one support arm to said at least one support leg.

10. The support system of claim 1, wherein said plurality of ridges is arranged in a radial configuration.

11. The support system of claim 1, wherein said at least one support leg is configured to pivot relative to said at least one support arm.

12. The supports system of claim 1, wherein said lower surface of said at least one support base is made of a non-slip material.

13. The support system of claim 1, wherein a first of said at least one support arm is configured to pivot relative to a first ladder leg.

14. The support system of claim 13, wherein a second of said at least one support arm is configured to pivot relative to a second ladder leg.

15. The support system of claim 1, further comprising a coupling means attached to said at least one support bracket.

16. The support system of claim 15, wherein said coupling means is configured to removably couple said upper end of said at least one support arm to said at least one support bracket.

17. A support system for providing support to a ladder, said support system comprising:
at least one support arm, said at least one support arm having an upper end and a lower end;
at least one support leg, said at least one support leg being removably attached to said lower end of at least one support arm;
at least one support base, said at least one support base being coupled to said at least one support leg and having a plurality of ridges on a lower surface of said support base;
at least one support bracket, said at least one support bracket being removably attached to said upper end of said at least one support arm;
wherein said at least one support arm is a telescoping support arm;
wherein said telescoping support arm is configured to extend said support arm in an outward direction;
wherein said lower end of said at least one support arm is cylindrical in shape;
wherein said support arm is comprised of two sections;
wherein a first of said sections is smaller in size than a second of said sections;
wherein said first section is removably attached to said second section via an attachment means;
further comprising a fastening means located on said lower end of said at least one support arm;
wherein said fastening means is configured to removably attach said at least one support arm to said at least one support leg;
wherein said plurality of ridges is arranged in a radial configuration;
wherein said at least one support leg is configured to pivot relative to said at least one support arm;
wherein said lower surface of said at least one support base is made of a non-slip material;
wherein a first of said at least one support arm is configured to pivot relative to a first ladder leg;
wherein a second of said at least one support arm is configured to pivot relative to a second ladder leg;
further comprising a coupling means attached to said at least one support bracket;
wherein said coupling means is configured to removably couple said upper end of said at least one support arm to said at least one bracket; and
wherein said support system is configured to provide support and relative horizontal and vertical stability to said ladder.

18. The support system of claim 17, further comprising set of instructions; and
wherein the support system is arranged as a kit.

19. A method of using a support system for a ladder, the method comprising the steps of:
providing at least one support arm, said at least one support arm having an upper end and a lower end, at least one support leg, said at least one support leg being removably attached to said lower end of at least one support arm, at least one support base, said at least one support base being coupled to said at least one support leg and having a plurality of ridges on a lower surface of said support base, at least one support bracket, said at least one support bracket being removably attached to said upper end of said at least one support arm; and
attaching said support system to said ladder.

20. The method of claim 19, further comprising the steps of:
placing said ladder in a desired work area; and
adjusting said at least one support arm and at least one support leg to a desired position.
